(19) United States
(12) Patent Application Publication
(10) Pub. No.: US 2015/0183137 A1
(43) Pub. Date: Jul. 2, 2015

(54) SEAT FOAM TOOL LID GROOVE VENTING

(71) Applicant: Lear Corporation, Southfield, MI (US)

(72) Inventors: Gary Rock, Canton, MI (US); Stephen D. Jackson, Clare, MI (US); Shannon Redmon, Roseville, MI (US); Gregory Alan Lymburner, Carleton, MI (US)

(21) Appl. No.: 14/581,406

(22) Filed: Dec. 23, 2014

Related U.S. Application Data
(60) Provisional application No. 61/922,152, filed on Dec. 31, 2013.

(51) Int. Cl. B29C 33/42; B29D 99/00; B29C 33/10

(52) U.S. Cl. CPC B29C 33/42; B29C 33/10; B29D 99/0092

(57) ABSTRACT

The present disclosure relates to a mold tool for forming foam, wherein the mold tool comprises a first mold half having a first interior surface, a second mold half having a second interior surface, the first and second interior surfaces, when the mold halves are closed, cooperating to form a cavity, at least one vent that communicates with one of an interior surface of one of the mold halves, and a generally v-shaped groove disposed on the interior surface and in communication with the vent.

### CROSS-REFERENCE TO RELATED APPLICATIONS

This application claims the benefit of U.S. provisional application Ser. No. 61/922,152 filed Dec. 31, 2013, the disclosure of which is hereby incorporated in its entirety by reference herein.

### TECHNICAL FIELD

The present application is directed to a mold tool assembly, and in particular, to a mold tool assembly having lid groove venting.

### BACKGROUND

Foam cushions have been made of molded polyurethane foam and other materials for many years. Mold tools typically comprise two mold halves that cooperate to form a mold in mold tools cavity. Polyurethane foam is commonly formed by introducing polyurethane forming components, such as polyol and isocyanate, into a mold to polymerize to form polyurethane foam. The polyurethane components form gas that needs to be vented during molding operations. Improper venting can result in foam cushions that have possible defects. For instance, improper venting can result in processability problems and/or foam cushion voiding.

### SUMMARY

According to at least one aspect of the present disclosure, a mold tool for forming foam is provided. In at least one embodiment, the mold tool comprises a first mold half having a first interior surface, and a second mold half having a second interior surface, which, when the mold halves are closed, cooperate to form a cavity, at least one vent that communicates with the first interior surface, and a generally v-shaped groove disposed on the first interior surface and in communication with the vent, wherein the groove has a mouth having a width of at least 8 mm.

According to another aspect of the present disclosure, a method for of making a mold tool for forming polyurethane foam for vehicle seat cushions is provided. In at least one embodiment, the method comprises providing a mold tool comprising a first mold half having a first molding surface, a second mold half having a second molding surface, with the first and second molding surfaces being cooperable to form a mold cavity, providing a plurality of generally v-shaped grooves on the first molding surface, wherein the grooves each have a mouth having a width of at least 8 mm, a depth that is less than the width of the mouth, and with a ratio of the width of the mouth to the depth of the groove being 1.1 to 1.75, and providing a plurality of spaced apart vents on the first mold half that communicate with the first molding surface and the plurality of grooves.

### BRIEF DESCRIPTION OF THE DRAWINGS

FIG. 1 is a cut-away environment view of a representative seat assembly;

FIG. 2 is a schematic side view of a representative cushion for use with the seat assembly of FIG. 1;

FIG. 3 is a schematic sectional view at a representative foam cushion mold;

FIG. 4 is a schematic plan view of a representative mold half with representative venting shown;

FIG. 5 is a schematic perspective view of another representative mold half with other venting shown;

FIG. 6 illustrates a side view of a representative mold surface with a representative groove vent; and

FIGS. 7A, 7B and 7C illustrate three schematic side views with each showing an embodiment of a mold surface with a different groove vent.

### DETAILED DESCRIPTION

As required, detailed embodiments of the present disclosure are disclosed herein; however, it is to be understood that the disclosed embodiments are merely examples of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Moreover, except where otherwise expressly indicated, all numerical quantities in this disclosure are to be understood as modified by the word “about” in describing the broader scope of this disclosure. Practice within the numerical limits stated is generally preferred. Also, unless expressly stated to the contrary, the description of a group or class of materials by suitable or preferred for a given purpose in connection with the disclosure implies that mixtures of any two or more members of the group or class may be equally suitable or preferred.

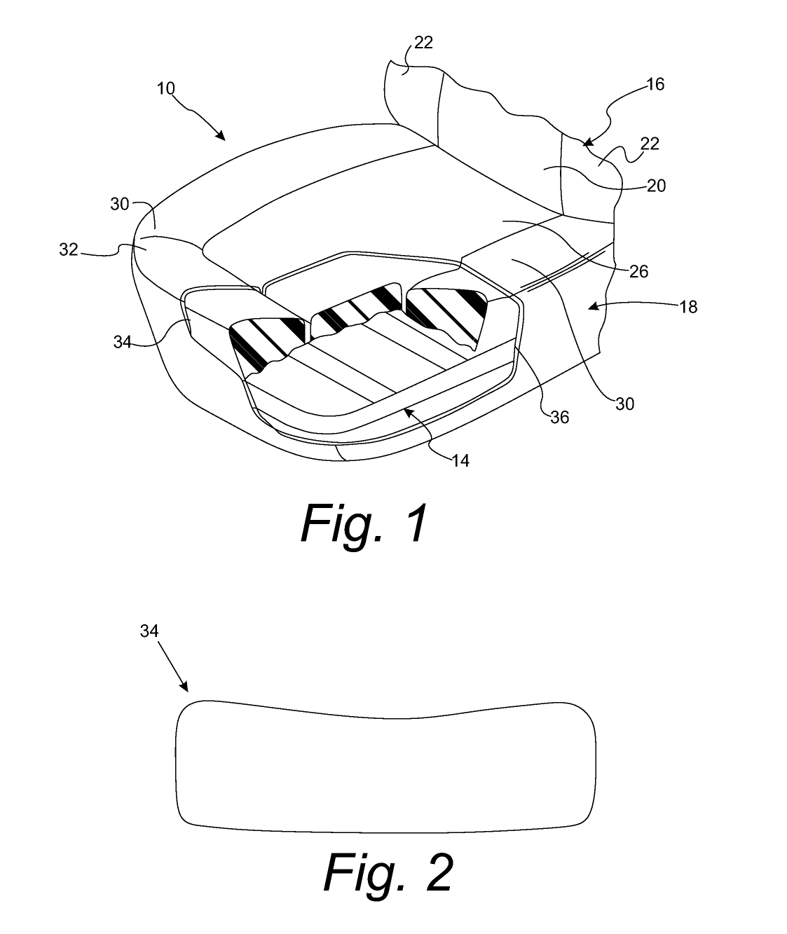

Referring now to the figures, where like numerals are used to designate like structure throughout the drawings, a schematic vehicle seat assembly in accordance with at least one embodiment of the present disclosure is generally shown at 10 in FIG. 1. While this vehicle seat assembly 10 is illustrated in FIG. 1 to be a rear bucket seat assembly, it should be understood that the principles of this disclosure are applicable to other types of seat assemblies, such as bench, captain and other types of seat assemblies. It should also be understood that the principles of the present disclosure are applicable to other applications where foam is a component, such as back rests, back support pads, arm rests, and head restraints. Moreover, it should be understood that the principles of this disclosure are also applicable to other seat rows, such as the front and third rows of seats. Still further, it should also be understood that the principles of this disclosure are applicable to all types of vehicle seat assemblies as well as non-vehicle seat assemblies.

As shown in FIG. 1, the vehicle seat assembly 10 includes a seat frame, generally indicated at 14, having a plurality of mounting brackets (not shown) adapted to operatively secure the seat frame within a vehicle. The seat frame 14 may be constructed from any material suitable for application within a vehicle seat assembly 10, such as aluminum, steel or other metal alloy or a suitable polymer. Further, the seat frame 14 may be manufactured using a technique commonly known in the art, relative to the type of material employed. By way of example, manufacturing techniques may include stamping, welding, fastening or molding a suitable material to form a seat frame 14.

The vehicle seat assembly 10 comprises a seat back, generally indicated at 16, and a lower seat assembly, generally indicated at 18. In at least the illustrated embodiment, the seat back 16 includes a central back support pad 20 and side bolsters 22 on opposite sides of the pad 20. In at least the illustrated embodiment, the lower seat assembly 18 includes a central seating pad 26 and a plurality of bolsters 30 and 32 substantially surrounding at least two opposing sides, and as shown here, three sides, of the central seating pad 26. In the illustrated embodiment, bolsters 30 are located at opposite sides (i.e., inboard and outboard) of the lower seat assembly 18 and the bolster 32 is located at the front of the lower seat assembly 18 and extends between and connects the front portions of the bolsters 30.

The vehicle seat assembly 10 further includes a back foam cushion (not shown) and a seat foam cushion generally indicated at 34. The back foam cushion and the seat foam cushion 34 are similar in construction and, as such, only the seat foam cushion 34 will be discussed. The seat foam cushion 34 is conventionally secured to the seat frame 14 and/or a seat assembly infrastructure (not shown). The foam cushion 34 may be secured to the seat frame 14 and/or infrastructure by any method generally known in the art, such as by an adhesive or an interference fit. While the foam cushion 34 is illustrated to be a bucket-seat bottom cushion, it should be understood that the principles of the present disclosure can be applicable to any type of seat cushion, such as a seat back cushion for a bucket-seat and seat back and bottom cushion for bench seats, as well as other types of seats.

The cushion 34 can be any suitable size, shape, and configuration, however, in at least one embodiment, the cushion 34 has an average thickness of 20 to 100 mm, and in at least another embodiment of 30 to 70 mm, and in still yet other embodiments of 40 to 60 mm.

The cushion 34 can comprise any suitable cushion material, such as a suitable resilient polymer. In at least one embodiment, suitable cushion materials will have a density of 1.5 to 4.5 pcf, in another embodiment of 2.0 to 3.75 pcf, and in yet other embodiments of 2.7 to 3.0 pcf. Density of the cushion material can be measured by ASTM test method No. D3574. In at least one embodiment, suitable cushion materials will have a hardness at 75% deflection of 175 to 400 N/mm², in other embodiments of 225 to 350 N/mm², and in yet other embodiments of 275 to 325 N/mm². Hardness of the cushion can be measured by ASTM test method No. D3574.

In at least certain embodiments, the cushion material comprises a soft flexible foam, such as conventional polyurethane foam, soy-based foam, silicone, thermoplastic olefins, thermoplastic urethanes, and/or natural oil-based expanded polyurethanes and the like. In other embodiments, the cushion material could be a non-polyurethane material. In at least one embodiment, because of its environmentally friendly nature, soy-based polyurethane can be used. Soy-based polyurethane can be made with any suitable soy-based polyols, such as those available, but not necessarily limited to, from Bayer, Urethane Soy Systems, and Dow Chemical.

The vehicle seat assembly 10 also includes trim material 36 which is adapted to cover the cushion 34 and the frame 14 in a covering relationship in any suitable manner. The trim material 36 may include any material known in the art. By way of example, some of the known materials include cloth, leather or polymers of sufficient quality and thickness for use in seat trim applications. Polymer trim materials may include a flexible close cell polymer skin material such as polyvinyl, polyvinyl chloride (PVC), polyester, nylon, thermoplastic olefin (TPO) or thermoplastic urethane (TPU). Additional materials for use as trim material 36, may include a foam backing (not shown, but generally known in the art) which may be manufactured from a variety of polymer foam materials. By way of example, the foam backing may be polyethylene, polypropylene, polyurethane, or a polystyrene foam. Optionally, a mesh or reinforcing material (not shown, but generally known in the art) such as fiberglass, nylon, polyester or natural fibers may be applied to the foam backing or back of the trim material 36 for increase in strength without increasing rigidity.

A comfort pad can optionally be provided and can comprise any suitable comfort layer or pad that can be made of a suitable material that provides good hand, feel, and soft resilience to the seat assembly. In embodiments where a comfort pad is provided, the comfort pad is typically located between the cushion 34 and the trim material 36.

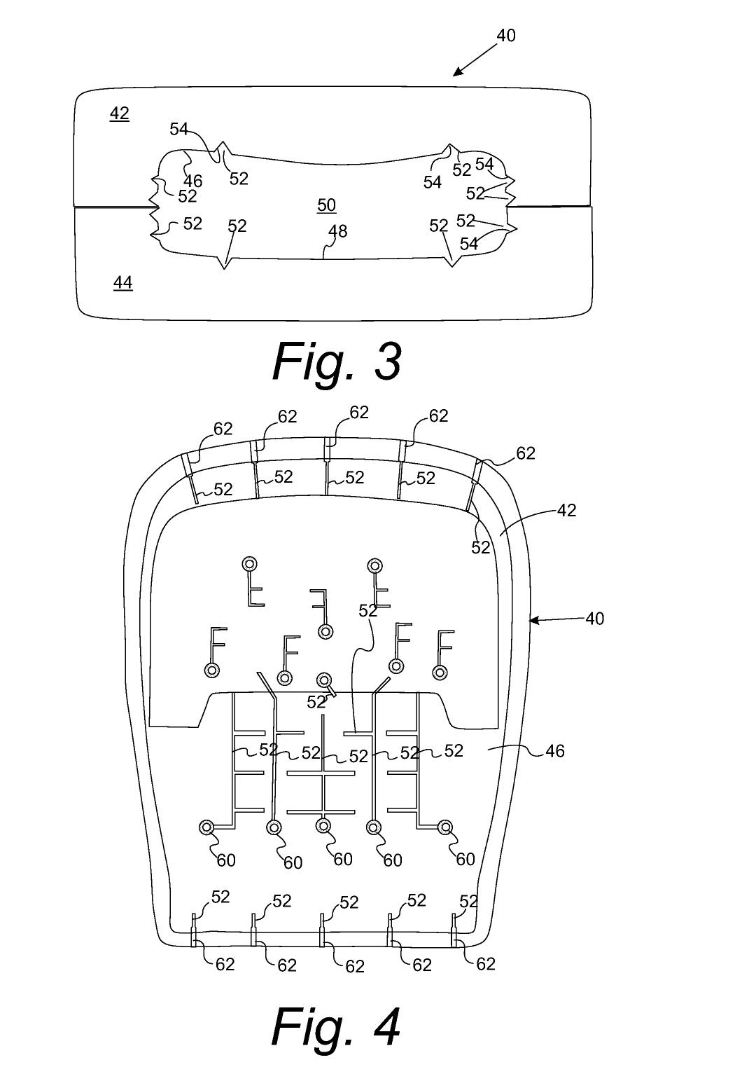

Referring to FIG. 2, an representative cushion 34 is shown. The cushion 34 is made in a cushion molding tool. Referring to FIG. 3, one embodiment of a representative molding tool 40 is illustrated. The molding tool 40 has a first mold half 42 and a second mold half 44. The first mold half 42 has a first interior mold surface 46 and the second mold half 44 has a second interior mold surface 48. The mold halves 42 and 44 cooperate so their respective interior mold surfaces 46 and 48 cooperate to form a mold cavity 50. As is well understood, polyurethane, or other foam, forming materials is disposed within the mold cavity 50 and cured to form a seat cushion 34. During the molding operation, it is desired to allow gasses created from the foam forming reaction to escape from the cavity 50 of the molding tool 40. The mold surfaces 46 and 48 have grooves 52 that connect to vents, such as seal vents and/or auto-vents, to vent gases generated in the mold cavity 50 to the atmosphere. The grooves 52 are defined by groove surfaces 54. In at least the illustrated embodiments, one or more, or all, of the grooves 52 are generally V-shaped, and in other embodiments are V-shaped. As shown in the figures, generally V-shaped and V-shaped is a mouth wider than the base with surface narrowing from the mouth to the base.

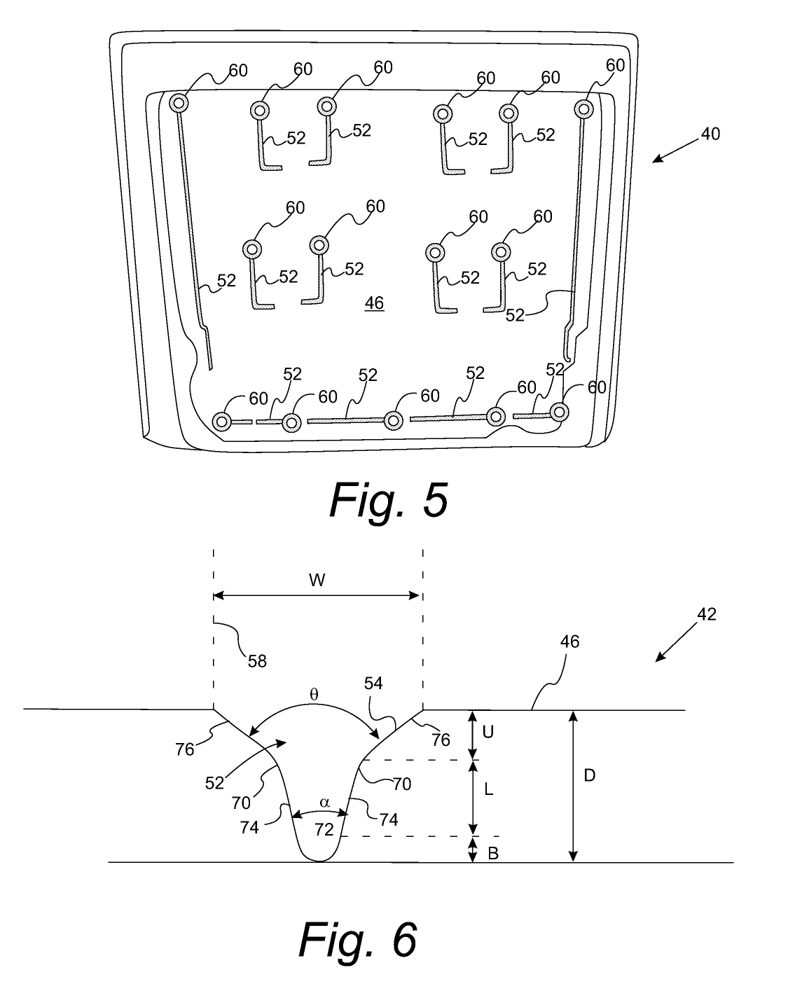

Referring to FIGS. 4 and 5, certain embodiments of representative pathways and venting configurations are shown. It should be understood that the representative pathways and venting configurations shown in FIGS. 4 and 5 are for illustrative purposes only and that the principles of the present disclosure are applicable to other embodiments, pathways and venting configurations.

Referring to FIG. 4, grooves 52 are shown that lead from the interior surface 46 of the first mold half 42 to vents 60 and 62 that expel gas to the exterior of the mold tool 40. Representatively shown in FIG. 4 is what is referred to as “auto vents” 60 and “seal vents” 62. Auto vents 60 provide gas release locations to vent gases from inside the cavity 50 to outside the mold tool 40. An auto vent 60 is known in the art and is a generally a pneumatically controlled cylinder with a chamfered post that allows gasses created in the cavity 50 to escape to outside the mold tool 40. Representative auto vents are shown in FIG. 5 as well. A seal vent 62 is known in the art and is generally a relatively flat and wide opening at the outside edges of the mold tool 40 that allow the gasses created in the cavity 50 to escape to outside the mold tool 40. The auto and seal vents 60 and 62 are strategically placed about the mold tool 40 in any suitable arrangement to allow the gasses to escape and to control foam part quality. In addition, or alternative to, other types of vents than auto vents and seal vents, such as blind holes (not shown), can be used. The location and number of vents 60 and 62 can be varied as desired. Moreover, the size, length and number of grooves 52 can be varied as desired as well.

Referring to FIG. 6, a respective groove 52 is shown in the surface 46 of mold half 42. While shown in mold half 42, it should be understood that the principles and characteristics described below with respect to grooves in mold half 42 apply to mold half 44 and other molding arrangements as well. In this embodiment, the groove 52 is defined by a surface 54 that extends outwardly away from the internal mold surface 46 of the mold tool 42. In the illustrated embodiment, the grooves 52 has a mouth 58 having a width W of at least 8.0 mm, and in at least one embodiment have a width of 8.0 to 9.0 mm, in another embodiment of 8.05 to 8.5 mm, in yet another embodiment of 8.10 to 8.3 mm, and in still yet another embodiment of 8.13 mm. In at least the illustrated embodiment, the mouth 58 is defined by the intersection of the edges of the groove 54 in the mold surface 46. In at least one embodiment, the groove 52 has a depth D of less than the width W of the mouth 58. In certain embodiments, the groove has a depth D of 6 mm, and in at least another embodiment have a depth of 5.75 to 6.5 mm, and in yet another embodiment of 5.9 to 6.25 mm. As can be seen, the groove 52 narrows and taper into the tool 40 away from the mold surface 46. In at least one embodiment, the ratio of the width W of the mouth 58 to the depth D of the groove 52 is 1.1 to 1.75, in another environment 1.15 to 1.5, in yet another embodiment 1.2 to 1.45, and in still yet another embodiment 1.3 to 1.4.

In at least certain embodiments, the groove 52 has a base, an upper portion adjacent to the mouth and a lower portion adjacent the base, such that the upper portion extends between and connects the mouth and the lower portion. In at least the illustrated embodiment, the upper portion extends from the mouth 58 to the tangent of the first radius of the groove 52, and is represented schematically as U. In at least the illustrated embodiment, the lower portion extends from the tangent of the first radius of the groove 52 to the tangent of the second radius of the groove, and is represented schematically as L. In at least the illustrated embodiment, the base extends from the bottom of the groove 52 to the tangent of the second radius, and is represented schematically as B.

In one embodiment, the upper portion U extends for 7.5 to 45% of the depth D of the groove 52, in another embodiment for 10 to 40% of the depth D of the groove, in yet another embodiment for 12 to 33% of the depth D of the groove, and in still yet another embodiment for 11 to 20% of the depth D of the groove 52. In one embodiment, the lower portion L extends for 40 to 90% of the depth D of the groove, in another embodiment for 50 to 85% of the depth D of the groove, in yet another embodiment for 55 to 82% of the depth D of the groove, and in still yet another embodiment for 65 to 80% of the depth D of the groove. In one embodiment, the base B extends for 0.5 to 15% of the depth D of the groove 52, in another embodiment for 1 to 10% of the depth D of the groove, in yet another embodiment for 5 to 9% of the depth D of the groove, and in still yet another embodiment for 6 to 8% of the depth D of the groove.

In at least certain embodiments, the lower portion L of the groove 52 has a maximum width that is 30 to 90% of the width of the mouth 52, in other embodiments that is 35 to 80%, and in yet other embodiments of 50 to 75%. In at least certain embodiments, the midpoint (depth wise) of the groove 52 has a width that is 20 to 50% of the width of the mouth 52, in other embodiments that is 25 to 45%, and in yet other embodiments of 30 to 40%. In at least one embodiment, the width of the groove 52 at the midpoint (depth wise) of the groove is 1.5 to 4.5 mm, in other embodiments 2 to 4 mm, and in yet other embodiments 2.5 to 3.25 mm. In at least one embodiment, the width of the groove 52 at the tangent of the second radius is 2 to 7.5 mm, in other embodiments 3 to 7 mm, and in yet other embodiments 3.5 to 5.5 mm. In at least one embodiment, the width of the groove 52 at the tangent of the first radius is 0.75 to 3 mm, in other embodiments 1 to 2.5 mm, and in yet other embodiments 1.25 to 2 mm. In certain embodiments, the width of the groove 52 at the tangent of the first radius is 1.5 to 8 times the width of the groove 52 at the tangent of the second radius, in other embodiments 2 to 6 times the width of the groove 52 at the tangent of the second radius, and in yet other embodiments 2.5 to 5 times the width of the groove 52 at the tangent of the second radius. In certain embodiments, the width of the mouth 58 is 4 to 7 times the width of the groove 52 at the tangent of the second radius, in other embodiments 5 to 6.5 times the width of the groove 52 at the tangent of the second radius, and in yet other embodiments 5.5 to 6 times the width of the groove 52 at the tangent of the second radius.

Continuing making reference to FIG. 6, the groove 52 generally has a first radius 70 extending from the mouth 58 towards the base B and a second radius 72 at the base. In at least one embodiment, the first radius 70 is between 0.05 and 0.35 mm, in another embodiment between 0.075 and 0.25 mm, in yet another embodiment between 0.09 and 0.2 mm, and in still yet another embodiment between 0.1 and 0.15 mm. In at least one embodiment, the second radius 72 is between 0.0075 and 0.15 mm, in another embodiment between 0.01 and 0.1 mm, in yet another embodiment between 0.02 and 0.08 mm, and in still yet another embodiment between 0.03 and 0.05 mm. In certain embodiments, the first radius 70 transitions into second radius 72. In other embodiments, flat surfaces 74 extend between and connect the surfaces defined by the first and second radii 70 and 72. In other embodiment, two sets 74 and 76 of spaced apart flat surfaces can be provided. As best seen in FIG. 6, spaced apart flat surfaces 76 extend between and connect the surfaces defined by the first radius 70 and the mouth 58. In at least one embodiment, the flat surfaces 74 extend an angle a away from the base B relative to each other at 15 to 40°, in another embodiment at 20 to 35° and in yet another embodiment at 22 to 29°. In at least one embodiment, the flat surfaces 76 extend an angle θ away from the base B relative to each other at 80 to 125°, in another embodiment at 90 to 115° and in yet another embodiment at 97 to 107°.

The grooves 52 can be terminated 0 to 15 mm, and in other environments 5 to 10 mm, from the tool seal, however, the grooves could terminate a different distance from the tool seal as desired. Also, while the grooves 52 are shown connected with vents 60 and 62, it should be understood that some or all of the grooves 52 could terminate some distance, such as up to 5 mm, from the front of one or more vents.

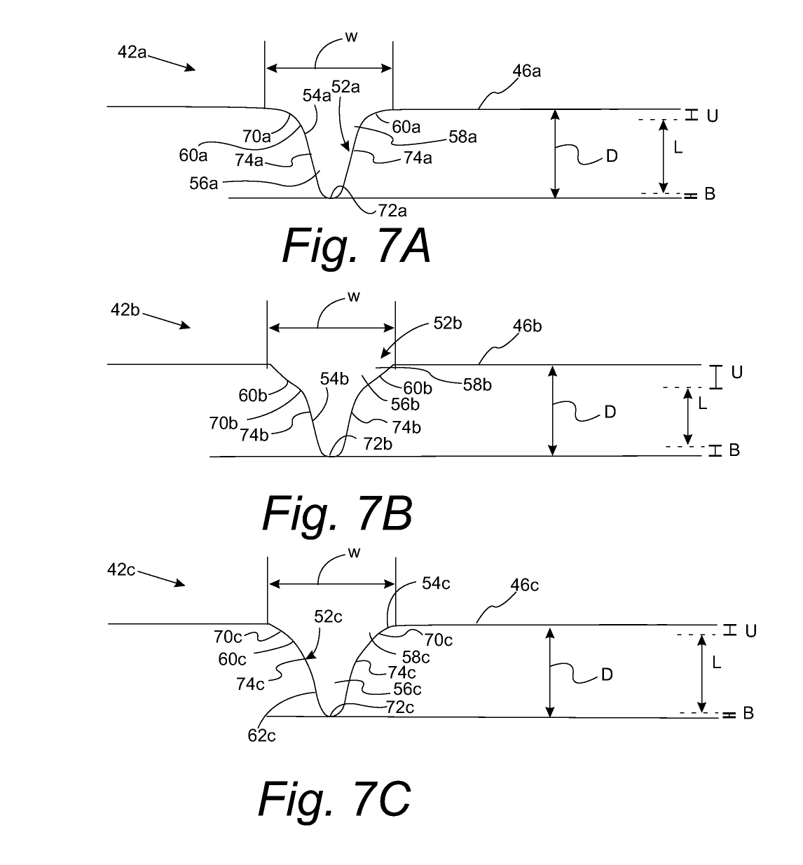

Referring to FIGS. 7A, 7B and 7C, three embodiments of grooves 52a, 52b, and 52c are shown. In each embodiment, each of the grooves 52a, 52b, and 52c is defined by a surface 54a, 54b, and 54c, respectively that extends away from the internal mold surface 46 of the mold tool 40.

Referring to the embodiment illustrated in FIG. 7A, the groove 52a has a mouth 58a having a width W of at least 8.0 mm, and in at least one embodiment have a width of 8.0 to 9.0 mm, in another embodiment of 8.05 to 8.5 mm, in yet another embodiment of 8.10 to 8.3 mm, and in still yet another embodiment of 8.13 mm. In at least the illustrated embodiment, the mouth 58a is defined by the intersection of the edges of the groove 54a in the mold surface 46a. In at least one embodiment, the groove 52a has a depth D of less than the width W of the mouth 58a. In certain embodiments, the groove 52a has a depth D of 6 mm, in at least another embodiment of 5.75 to 6.5 mm, and in yet another embodiment of 5.9 to 6.25 mm. As can be seen, the groove 52a narrows and taper into the tool 40 away from the mold surface 46a. In at least one embodiment, the ratio of the width W of the mouth 58a to the depth D of the groove 54a is 1.1 to 1.75, in another environment 1.15 to 1.5, in yet another embodiment 1.2 to 1.45, and in still yet another embodiment 1.3 to 1.4.

In one embodiment, the upper portion U of the groove 52a extends for 7.5 to 25% of the depth D of the groove 52a, in another embodiment for 9.5 to 20% of the depth D of the groove 52a, in yet another embodiment for 10 to 15% of the depth D of the groove 52a, and in still yet another embodiment for 10.5 to 14% of the depth D of the groove 52a. In one embodiment, the lower portion L of the groove 52a extends for 65 to 90% of the depth D of the groove of the groove 52a, in another embodiment for 70 to 88% of the depth D of the groove 52a, in yet another embodiment for 75 to 86% of the depth D of the groove 52a, and in still yet another embodiment for 78 to 84% of the depth D of the groove 52a. In one embodiment, the base B of the groove 52a extends for 0.5 to 15% of the depth D of the groove 52a, in another embodiment for 1 to 10% of the depth D of the groove 52a, in yet another embodiment for 5 to 9% of the depth D of the groove 52a, and in still yet another embodiment for 6 to 8% of the depth D of the groove 52a.

In at least the illustrated embodiment, the groove 52a has a first radius 70a extending from the mouth 58a towards the base B and a second radius 72a at the base. In at least one embodiment, the first radius 70a is between 0.025 and 0.25 mm, in another embodiment between 0.05 and 0.20 mm, in yet another embodiment between 0.075 and 0.15 mm, and in still yet another embodiment between 0.09 and 0.12 mm. In at least one embodiment, the second radius 72a is between 0.0075 and 0.15 mm, in another embodiment between 0.01 and 0.1 mm, in yet another embodiment between 0.02 and 0.08 mm, and in still yet another embodiment between 0.025 and 0.04 mm. In at least one embodiment, flat surfaces 74a extend between and connect the surfaces defined by the first and second radii 70a and 72a. In at least one embodiment, the flat surfaces 74a extend an angle away from the base of groove 52a relative to each other at 15 to 40°, in another embodiment at 20 to 35° and in yet another embodiment at 22 to 29°.

Continuing making reference to FIG. 7A, the groove 52a has a generally narrow mouth 58a and a relatively narrow channel 56a. In at least this embodiment, the illustrated groove 52a has two opposed arcuate shoulder portions 60a that extend in at least one embodiment about 2 mm, and in another embodiment about 1.75 to 2.25 mm, from the interior surface 46a to the two opposed generally planar surfaces 74a. Each of the generally planar surfaces 74a extend from a respective one of the shoulder portions 60a in at least one embodiment about 5 mm, and in another embodiment 4.75 to 5.25 mm, and towards each other to the base. In at least one embodiment, the generally planar surfaces 74a extend from the base away from each other at an angle of 20 to 35° , in another embodiment of 22 to 30°, and in yet another embodiment of 25 to 28°.

Referring to the embodiment illustrated in FIG. 7B, the groove 52b has a mouth 58b having a width W of at least 8.0 mm, and in at least one embodiment have a width of 8.0 to 9.0 mm, in another embodiment of 8.05 to 8.5 mm, in yet another embodiment of 8.10 to 8.3 mm, and in still yet another embodiment of 8.13 mm. In at least the illustrated embodiment, the mouth 58b is defined by the intersection of the edges of the groove 54b in the mold surface 46b. In at least one embodiment, the groove 52b has a depth D of less than the width W of the mouth 58b. In certain embodiments, the groove 52b has a depth D of 6 mm, in at least another embodiment of 5.75 to 6.5 mm, and in yet another embodiment of 5.9 to 6.25 mm. As can be seen, the groove 52b narrows and taper into the tool 40 away from the mold surface 46b. In at least one embodiment, the ratio of the width W of the mouth 58b to the depth D of the groove 54b is 1.1 to 1.75, in another environment 1.15 to 1.5, in yet another embodiment 1.2 to 1.45, and in still yet another embodiment 1.3 to 1.4.

In one embodiment, the upper portion U of the groove 52b extends for 20 to 45% of the depth D of the groove 52b, in another embodiment for 25 to 40% of the depth D of the groove 52b, in yet another embodiment for 28 to 38% of the depth D of the groove 52b, and in still yet another embodiment for 30 to 35% of the depth D of the groove 52b. In one embodiment, the lower portion L of the groove 52b extends for 40 to 70% of the depth D of the groove of the groove 52b, in another embodiment for 45 to 67.5% of the depth D of the groove 52b, in yet another embodiment for 50 to 62% of the depth D of the groove 52b, and in still yet another embodiment for 52 to 60% of the depth D of the groove 52b. In one embodiment, the base B of the groove 52b extends for 0.5 to 15% of the depth D of the groove 52b, in another embodiment for 1 to 10% of the depth D of the groove 52b, in yet another embodiment for 5 to 9% of the depth D of the groove 52b, and in still yet another embodiment for 6 to 8% of the depth D of the groove 52b.

In at least the illustrated embodiment, the groove 52b has a first radius 70b extending from the mouth 58b towards the base B and a second radius 72b at the base. In at least one embodiment, the first radius 70b is between 0.025 and 0.25 mm, in another embodiment between 0.05 and 0.20 mm, in yet another embodiment between 0.075 and 0.15 mm, and in still yet another embodiment between 0.09 and 0.12 mm. In at least one embodiment, the second radius 72b is between 0.0075 and 0.15 mm, in another embodiment between 0.01 and 0.1 mm, in yet another embodiment between 0.02 and 0.08 mm, and in still yet another embodiment between 0.025 and 0.04 mm. In at least one embodiment, flat surfaces 74b extend between and connect the surfaces defined by the first and second radii 70b and 72b. In at least one embodiment, spaced apart flat surfaces 76b extend between and connect the surface defined by the first radius 70b and the mouth 58b. In at least one embodiment, the flat surfaces 74b extend an angle away from the base of groove 52b relative to each other at 15 to 40°, in another embodiment at 20 to 35° and in yet another embodiment at 22 to 29°. In at least one embodiment, the flat surfaces 76b extend an angle away from the base of the groove 52b relative to each other at 80 to 125°, in another embodiment at 90 to 115° and in yet another embodiment at 97 to 107°.

Continuing making reference to FIG. 7B, the groove 52b has a relatively wide and long portion adjacent the mouth 58b such that the shoulder portions 60b have a greater angle than the shoulder portion 60a. The two opposed arcuate shoulder portions 60b extend in at least one embodiment about 1.4 mm, and in another embodiment 1.2 to 1.6 mm, from the interior surface 46b to two opposed generally planar surfaces 74b. Each of the generally planar surfaces 74b extend from a respective one of the shoulder portions 60b in at least one embodiment about 5.5 mm, and in another embodiment of 5.25 to 5.75 mm, and towards each other to the base. In at least one embodiment, the generally planar surfaces 74b extend from the base away from each other at an angle of 20 to 35°, in another embodiment of 22 to 30°, and in yet another embodiment of 25 to 28°. The lower portion of the channel 56b is shorter than the lower portion of the channel 56a.

Referring to the embodiment illustrated in FIG. 7C, the groove 52c has a mouth 58c having a width W of at least 8.0 mm, and in at least one embodiment have a width of 8.0 to 9.0 mm, in another embodiment of 8.05 to 8.5 mm, in yet another embodiment of 8.10 to 8.3 mm, and in still yet another embodiment of 8.13 mm. In at least the illustrated embodiment, the mouth 58c is defined by the intersection of the edges of the groove 54c in the mold surface 46c. In at least one embodiment, the groove 52c has a depth D of less than the width W of the mouth 58c. In certain embodiments, the groove 52c has a depth D of 6 mm, in at least another embodiment of 5.75 to 6.5 mm, and in yet another embodiment of 5.9 to 6.25 mm. As can be seen, the groove 52c narrows and taper into the tool 40 away from the mold surface 46c. In at least one embodiment, the ratio of the width W of the mouth 58c to the depth D of the groove 54c is 1.1 to 1.75, in another environment 1.15 to 1.5, in yet another embodiment 1.2 to 1.45, and in still yet another embodiment 1.3 to 1.4.

In one embodiment, the upper portion U of the groove 52c extends for 7.5 to 25% of the depth D of the groove 52c, in another embodiment for 9.5 to 20% of the depth D of the groove 52c, in yet another embodiment for 10 to 15% of the depth D of the groove 52c, and in still yet another embodiment for 10.5 to 14% of the depth D of the groove 52c. In one embodiment, the lower portion L of the groove 52c extends for 65 to 90% of the depth D of the groove of the groove 52c, in another embodiment for 70 to 88% of the depth D of the groove 52c, in yet another embodiment for 75 to 86% of the depth D of the groove 52c, and in still yet another embodiment for 78 to 84% of the depth D of the groove 52c. In one embodiment, the base B of the groove 52c extends for 0.5 to 15% of the depth D of the groove 52c, in another embodiment for 1 to 10% of the depth D of the groove 52c, in yet another embodiment for 5 to 9% of the depth D of the groove 52c, and in still yet another embodiment for 6 to 8% of the depth D of the groove 52c.

In at least the illustrated embodiment, the groove 52c has a first radius 70a extending from the mouth 58c towards the base B and a second radius 72c at the base. In at least one embodiment, the first radius 70c is between 0.10 and 0.35 mm, in another embodiment between 0.125 and 0.25 mm, in yet another embodiment between 0.15 and 0.23 mm, and in still yet another embodiment between 0.19 and 0.22 mm. In at least one embodiment, the second radius 72c is between 0.0075 and 0.15 mm, in another embodiment between 0.01 and 0.1 mm, in yet another embodiment between 0.02 and 0.08 mm, and in still yet another embodiment between 0.025 and 0.04 mm. In at least one embodiment, flat surfaces 74c extend between and connect the surfaces defined by the first and second radii 70c and 72c. In at least one embodiment, the flat surfaces 74c extend an angle away from the base of groove 52c relative to each other at 15 to 40°, in another embodiment at 20 to 35° and in yet another embodiment at 22 to 29°.

Continuing making referring to FIG. 7C, the upper half of the groove 52c is relatively wide and deep such that relatively narrow portion of the channel 56c is shorter than for the other channels 56a and 56b. In at least the illustrated embodiment, the groove 52c has two opposed arcuate shoulder portions 60c that extend in at least one embodiment about 3 mm, and in another embodiment 2.75 to 3.25 mm, from the interior surface 46c to two opposed generally planar surfaces 74c. Each of the generally planar surfaces 74c extend from a respective one of the shoulder portions 60c in at least one embodiment about 4 mm, and in another embodiment of 4.75 to 5.25 mm, and towards each other to the base. In at least one embodiment, the generally planar surfaces 74c extend from the base away from each other at an angle of 20 to 35°, in another embodiment of 22 to 30°, and in yet another embodiment of 25 to 28°.

Venting with one or more of the illustrated designs results in a more robust groove design, which can provide improved part processability and reduction in part voiding. The grooves 52 have a relatively wide width and profile which provide a relatively high level of gas venting, which can result in improved B-surface foam quality, improved part quality, particularly with complex part designs, and controlled tearing of ribbon vents at desired locations.

The details, designs, variants, aspects and embodiments shown and described herein are applicable to automotive, other vehicular and non-regulated seating. While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A mold tool for forming foam, the mold tool comprising:
a first mold half having a first interior surface;
a second mold half having a second interior surface, the first and second interior surfaces, when the mold halves are closed, cooperating to form a cavity;
at least one vent that communicates with the first interior surface; and
a generally v-shaped groove disposed on the first interior surface and in communication with the vent, wherein the groove has a mouth having a width of at least 8 mm.

2. The mold tool of claim 1, wherein the groove has a mouth having a width of 8.0 to 9.0 mm.

3. The mold tool of claim 1, wherein the groove has a depth of no more than 6 mm.

4. The mold tool of claim 2, wherein the groove has a depth of no more than 6 mm.

5. The mold tool of claim 1, wherein the groove is defined at least in part by a first radius and a second radius, the groove having a base, an upper portion adjacent to the mouth and a lower portion adjacent the base, the mouth being defined by the intersection of the groove with the first interior surface, the upper portion extending from the mouth to the tangent of the first radius and the lower portion extending from the tangent of the first radius to the tangent of the second radius such that the upper portion extends between and connects the mouth and the lower portion, the base extending from the bottom of the groove to the lower portion of the groove such that the lower portion extends between the connects the upper portion and the base, the upper portion extending for 7 to 45% of the depth of the groove, the lower portion extending for 40 to 90% of the depth of the groove, and the base extending for 1 to 10% of the depth of the groove, the width of the base being less than the width of the upper portion.

6. The mold tool of claim 5, wherein the upper portion extends for 10 to 40% of the depth of the groove, the lower portion extends for 50 to 85% of the depth of the groove, and the base extends for 5 to 9% of the depth of the groove, the width of the base being less than the width of the upper portion.

7. The mold tool of claim 1, wherein flat surfaces extend between and connect the first radius and second radius.

8. The mold tool of claim 1, wherein the width of the mouth is 4 to 7 times the width of the groove at the tangent of the second radius.

9. The mold tool of claim 8, wherein the width of the groove at the depthwise midpoint of the groove is 1.5 to 4.5 mm.

10. The mold tool of claim 4, further comprising a ratio of the width of the mouth to the depth of the groove being 1.1 to 1.75.

11. A mold tool for forming polyurethane foam for vehicle seat cushions, the mold tool comprising:
a first mold half having a first molding surface;
a second mold half having a second molding surface, the first and second molding surfaces cooperable to form a mold cavity;
a plurality of spaced apart vents that communicate with the first molding surface; and
a plurality of generally v-shaped grooves disposed on the first molding surface, with each of the plurality of grooves in communication with at least one of the vents, wherein each of the grooves having a mouth having a width of at least 8 mm, a depth that is less than the width of the mouth, and having a ratio of the width of the mouth to the depth of the groove of 1.1 to 1.75.

12. The mold tool of claim 11, wherein each of the grooves have a mouth having a width of 8.0 to 9.0 mm.

13. The mold tool of claim 11, wherein each of the grooves have a depth of no more than 6 mm.

14. The mold tool of claim 11, wherein each of the grooves is defined at least in part by a first radius and a second radius, with each groove having a base, an upper portion adjacent to the mouth and a lower portion adjacent the base, with each mouth of the groove being defined by the intersection of the groove with the first interior surface and having the upper portion extend from the mouth to the tangent of the first radius and the lower portion extending from the tangent of the first radius to the tangent of the second radius such that the upper portion extends between and connects the mouth and the lower portion, and with the base of each groove extending from the bottom of the groove to the lower portion of the groove such that the lower portion extends between the connects the upper portion and the base, with the upper portion extending for 7 to 45% of the depth of the groove, the lower portion extending for 40 to 90% of the depth of the groove, and the base extending for 1 to 10% of the depth of the groove, and with the width of the base being less than the width of the upper portion.

15. The mold tool of claim 14, wherein, for each groove, the upper portion extends for 10 to 40% of the depth of the groove, the lower portion extends for 50 to 85% of the depth of the groove, and the base extends for 5 to 9% of the depth of the groove, with the width of the base being less than the width of the upper portion.

16. The mold tool of claim 11, wherein, for each groove, flat surfaces extend between and connect the first radius and second radius.

17. The mold tool of claim 11, wherein, for each groove, the width of the mouth is 4 to 7 times the width of the groove at the tangent of the second radius.

18. The mold tool of claim 17, wherein, for each groove, the width of the groove at the depthwise midpoint of the groove is 1.5 to 4.5 mm.

19. The mold tool of claim 11, wherein each groove has a ratio of the width of the mouth to the depth of the groove of 1.1 to 1.75.

20. A method of making a mold tool for forming polyurethane foam for vehicle seat cushions, the method comprising:
providing a mold tool comprising:
a first mold half having a first molding surface;
a second mold half having a second molding surface, the first and second molding surfaces cooperable to form a mold cavity;
providing a plurality of generally v-shaped grooves on the first molding surface, wherein the grooves each have a mouth having a width of at least 8 mm, a depth that is less than the width of the mouth, and with a ratio of the width of the mouth to the depth of the groove being 1.1 to 1.75; and
providing a plurality of spaced apart vents on the first mold half that communicate with the first molding surface and the plurality of grooves.
